(19) United States
(12) Patent Application Publication
(10) Pub. No.: US 2006/0163208 A1
(43) Pub. Date: Jul. 27, 2006

(54) Photoresist stripping composition and methods of fabricating semiconductor device using the same

(75) Inventors: Kwang-Myeon Park, Yongin-si (KR); Jae-Jin Kim, Yongin-si (KR); Sang-Jine Park, Yongin-si (KR); Hyun-Wook Rho, Suwon-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/328,018

(22) Filed: Jan. 9, 2006

(30) Foreign Application Priority Data
Jan. 25, 2005 (KR) 2005-6849

(51) Int. Cl. C23F 1/00; B44C 1/22; C03C 15/00; C09K 13/00

(52) U.S. Cl. 216/93; 252/79.1; 216/41; 216/83

(57) ABSTRACT

A photoresist stripping composition and a method of fabricating a semiconductor device using the photoresist stripping composition are provided. The photoresist stripping composition is made of a mixed solution of acetone and isopropyl alcohol. A preferred volume ratio of acetone to isopropyl alcohol is in a range of about 50:50 to about 95:5.

### CROSS-REFERENCE TO RELATED PATENT APPLICATION

This application claims the benefit of Korean Patent Application No. 10-2005-0006849, filed on Jan. 25, 2005, in the Korean Intellectual Property Office, the disclosure of which is incorporated herein in its entirety by reference

### BACKGROUND OF THE INVENTION

1. Field of the Invention

The present invention relates a photoresist stripping composition and a method of fabricating a semiconductor device using the photoresist stripping composition.

2. Description of the Related Art

A fine circuit fabricating process for a semiconductor integrated circuit is typically performed by uniformly applying photoresist on a conductive metal layer such as a copper layer and a copper alloy layer or an insulating layer such as a silicon oxide layer and a silicon nitride layer. The above fabrication process further includes selectively exposing and developing the resultant product to form a photoresist pattern, and then wet-etching or dry-etching the conductive metal layer or the insulating layer by using the photoresist pattern as an etching mask to transfer a fine circuit pattern to a photoresist underlying layer. Next, any unnecessary photoresist layer is removed with a stripper (a peeling solution).

The stripper for removing the photoresist should have the following characteristics set forth below.

Firstly, the stripper should have an excellent peeling capability such that it is able to peel off the photoresist in a short period of time at a low temperature and not leave any photoresist material remaining on the rinsed substrate. Secondly, the stripper should have a low corrosiveness so as not to damage the metal layer or the insulating layer underneath the photoresist layer. Thirdly, the solvents constituting the stripper should not be solvents which react with one another at room temperature and should also be stable at high temperatures, thereby ensuring that the stripper composition is able to be stored safely. Fourthly, the stripper should have a low toxicity for the benefit of workers' safety and also to avoid the environmental difficulties involved with waste disposal. Fifthly, the stripper composition should have a low volatility because if a large amount of the stripper is volatilized in a photoresist peeling process at a high temperature, the component ratio will vary too rapidly, thereby causing the stability and work reproducibility of the photoresist stripping process to deteriorate. Sixthly, the stripper should also be economical, so that a large number of wafers can be processed with a predetermined amount of the stripper, the components of the stripper can be easily acquired at a low price, and the waste stripper can be recycled.

To meet the aforementioned conditions or characteristics, various conventional photoresist stripping compositions have been developed. Some detailed examples of these conventional photoresist stripping compositions are set forth below.

One such example of an earlier-developed photoresist stripping composition is a stripping composition constructed with an alkyl allylic sulfonic acid, a 6- or 9-carbon hydrophilic aromatic sulfonic acid, and a non-halogenated aromatic hydrocarbon having a boiling point of 150° C. or more. The above photoresist composition is described in U.S. Pat. No. 4,256,294.

However, the above conventional composition has certain difficulties associated with it, such as being highly corrosive to a conductive metal layer such as a copper layer and a copper alloy layer. Moreover, this composition is highly toxic, and also harmful to the environment. Therefore, the use of the above-mentioned conventional photoresist stripping composition for semiconductor fabrication processes is undesirable.

To solve the above-mentioned difficulties, other conventional photoresist stripping compositions have been developed. These other stripping compositions are typically formed by mixing aqueous alkanol amine (essential component) with other organic solvents. For example, a two-component stripping composition constructed with an organic amine compound such as mono ethanol amine (MEA) and 2-(2-aminoethoxy)-1-ethanol (AEE) and a polar solvent such as dimethyl formamide (DMF), dimethyl acetamide (DMAc), N-methylpyrrolidinone (NMP), dimethyl sulfoxide (DMSO), carbitol acetate, propylene glycol mono methyl ether acetate (PGMEA) is described in U.S. Pat. No. 4,617,251. In addition, a two-component stripping composition constructed with an organic amine compound and an amide solvent such as N-methyl acetamide, dimethyl formamide (DMF), dimethyl acetamide (DMAc), N-methyl-N-ethyl propion amide, diethyl acetamide (DEAc), dipropyl acetamide (DPAc), N,N-dimethyl propion amide, and N,N-dimethyl butyl amide is described in U.S. Pat. No. 4,770,713. However, these photoresist stripping compositions have a weak corrosive resistance to copper and/or copper alloy layers. Thus, these compositions can cause severe corrosion during a stripping process and imperfect deposition of a gate insulating layer in a post process.

As can be gleaned from the above, there is a need for an economical stripping composition having optimal performance in various process conditions such as photoresist peeling capability, metal corrosiveness, post peeling rinsing process diversity, work reproducibility and storage safety.

In particular, the stripper solution should be a solution capable of selectively removing the photoresist layer without leaving any remaining photoresist materials on a rinsed substrate and which does not damage the underlying layer to a photoresist layer. Conventionally, acetone has been used as a stripper solution capable of removing the photoresist pattern without damaging the underlying layer located underneath the photoresist layer.

FIG. 1 is a schematic view showing a process for removing a photoresist layer by using a conventional acetone stripper.

Referring to FIG. 1, a wafer S1 having a photoresist pattern which is subject to a lower layer etching process is immersed in a bath P1 containing an acetone solution for one minute. At this time, the acetone solution is circulated, and the temperature of the acetone solution is maintained at 10 degrees Celsius.

Next, the wafer S where the photoresist pattern is peeled off is transferred to an isopropyl alcohol (IPA) bath P2 by using a robot arm. The wafer S is then rinsed in the isopropyl alcohol bath P2 for one minute. It is noted that if the wafer S where the photoresist pattern is peeled off is directly transferred to a water bath for rinsing without passing through the isopropyl alcohol bath P2, materials dissolved in the remaining stripper solution will be extracted on the substrate due to a solubility difference between the stripper solution and the other materials in water. Thus, the isopropyl alcohol bath P2 which is a bath for an intermediate rinsing process using an organic solvent is provided to prevent the materials dissolved in the remaining stripper solution from becoming extracted onto the wafer substrate.

The wafer S rinsed in the isopropyl alcohol bath P2 is then transferred to a quick drain rinse (QDR) bath P3 and rinsed by using deionized (D1) water. Next, the wafer S is transferred to a final rinse (F/R) bath P4 and finally rinsed by using deionized water. The rinsing-completed water S is then transferred to a rinse dryer (R/D) bath P5 and dried.

As described above, one of the difficulties in using a conventional acetone stripper in a process for removing a photoresist layer has to do with the volatility of acetone leading to a phenomenon known as black defect, Namely, when the wafer S where the photoresist pattern is peeled off in the acetone bath P1 is transferred to the isopropyl alcohol (IPA) bath P2 using the robot arm, particle adsorption may occur on a surface of the wafer S due to the volatility of acetone, thereby leading to black defect.

FIGS. 2A to 2D are cross sectional views of a wafer where black defect occurs due to particle adsorption in a case where a conventional acetone stripper is used.

FIG. 3 shows a plan view of the wafer where the black defect occurs in FIG. 2D and an enlarged photograph of a black defect region.

Referring to FIGS. 1 and 2A, a wafer S1 having a photoresist pattern 8 which is subject to a lower layer etching process is immersed in an acetone bath P1.

Referring to FIGS. 1 and 2B, the wafer S where the photoresist pattern 8 is peeled off is lifted up from the acetone bath P1 by using a robot arm. The acetone solution 300 on the surface of the wafer S flows under the wafer S due to gravitational force. The acetone solution 300 includes particles PA generated by peeling off the photoresist patterns 8.

Referring to FIGS. 1 and 2C, in an upper region of the wafer S, the acetone solution 300 flows downwards due to gravitational force, so that the acetone solution 300 is formed with a relatively thin layer. In addition, the acetone solution 300 formed with a thin layer is easily volatile, so that particles PA1 can be adsorbed into the surface of the wafer S. The adsorbed particles PA1 are not removed but rather are retained in subsequent rinsing processes, thereby leading to black defect.

Referring to FIGS. 1, 2D, and 3, FIG. 2D shows a wafer S obtained by rinsing the wafer S in the isopropyl alcohol IPA bath P2 and sequentially transferring the wafer W to a quick drain rinse (QDR) bath P3, a final rinse (F/R) bath P4, and a rinse dryer (R/D) bath P5 to be rinsed and dried as illustrated in FIG. 1. Further, as illustrated in FIG. 2C, the particles PA1 adsorbed into the upper regions of the wafer S are not removed but retained during the rinsing process. Therefore, as shown in FIG. 3, when the wafer is lifted up in a vertical direction, a black defect region PA0 is formed in the upper region of the wafer. By enlarging and observing a “R1” region, it can be seen that black defect specks PA2 are formed due to particles PA1.

Therefore, there is a need for a photoresist stripper solution which is not only capable of selectively removing the photoresist layer without leaving any remaining photoresist materials behind on a rinsed substrate and does not damage the underlying layer to a photoresist layer, but which also prevents particle absorption on the surface of the substrate which leads to black defect caused by solution volatilization during the transfer to the rinsing process.

### SUMMARY OF THE INVENTION

According to an exemplary embodiment of the present invention, a photoresist stripping composition is provided. The photoresist stripping composition consists of a mixed solution of acetone and isopropyl alcohol.

According to another exemplary embodiment of the present invention, a method of fabricating a semiconductor device is provided. The method comprises forming an underlayer on a semiconductor substrate. A photoresist layer is formed on the underlayer. The photoresist layer is patterned to form a photoresist pattern. By using the photoresist pattern as an etching mask, the underlayer is etched. The semiconductor substrate is immersed in a photoresist stripping composition bath containing a mixed solution of acetone and isopropyl alcohol to remove the photoresist pattern. The semiconductor substrate is then transferred to an isopropyl alcohol bath to be rinsed. The semiconductor substrate is then transferred to a deionized water bath to be rinsed. Next, the semiconductor substrate is dried.

According to another exemplary embodiment of the present invention, a method of fabricating a semiconductor device is provided. The method comprises preparing a semiconductor substrate where an image sensor having a pad photoresist pattern is provided. The semiconductor substrate is then immersed in a photoresist stripping composition bath containing a mixed solution of acetone and isopropyl alcohol to remove the pad photoresist pattern. The semiconductor substrate is then transferred to an isopropyl alcohol bath to be rinsed. The semiconductor substrate is then transferred to a deionized water bath to be rinsed. Next, the semiconductor substrate is dried.

### BRIEF DESCRIPTION OF THE DRAWINGS

FIG. 1 is a schematic view showing a process for removing a photoresist layer by using a conventional acetone stripper;

FIGS. 2A to 2D are cross sectional views of a wafer where black defect occurs due to particle adsorption in a case where a conventional acetone stripper is used;

FIG. 3 shows a plan view of the wafer where the black defect occurs in FIG. 2D and an enlarged photograph of a black defect region;

FIG. 4 is a schematic view of a bath for explaining a method of fabricating a photoresist stripping composition according to an exemplary embodiment of the present invention;

FIG. 5 is a schematic block diagram of image sensors according to an exemplary embodiment of the present invention;

FIGS. 6A to 6E are cross sectional views taken along line I-I′ for explaining methods of fabricating image sensors shown in FIG. 5;

FIG. 7 is a schematic view of a bath for explaining a process for removing the photoresist pattern by using a photoresist stripping composition according to an exemplary embodiment of the present invention in FIG. 6E;

FIGS. 8A to 8C are cross sectional views of a wafer for explaining a process for removing a photoresist pattern by using a photoresist stripping composition according to an exemplary embodiment of the present invention;

FIG. 9 is a graph comparing production yield of image sensors fabricated by using a conventional technique with production yield of image sensors fabricated by using a photoresist removing process according to an exemplary embodiment of the present invention; and

FIG. 10 is a graph showing ratios of black defects to defects generated when image sensors are fabricated according to the conventional technique and the exemplary embodiment of the present invention in FIG. 9.

### DETAILED DESCRIPTION OF THE EXEMPLARY EMBODIMENTS OF THE INVENTION

The present invention will now be described more fully with reference to the accompanying drawings, in which exemplary embodiments of the invention are shown. The invention may, however, be embodied in many different forms and should not be constructed as being limited to the embodiments set forth herein. In the drawings, the thicknesses of layers and regions are exaggerated for clarity. Like reference numerals in the specification denote like elements.

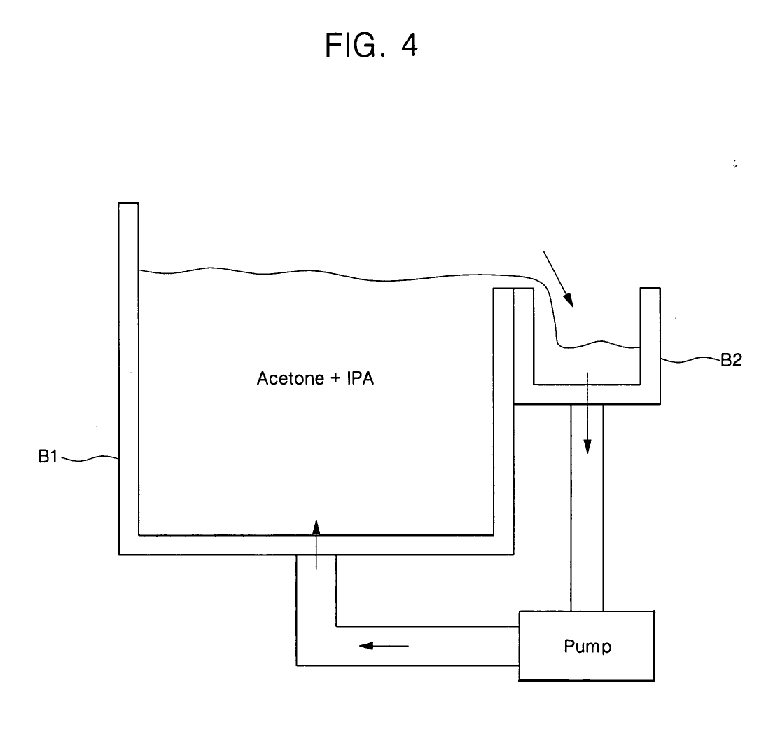

FIG. 4 is a schematic view of a bath for illustrating a method of fabricating a photoresist stripping composition according to an exemplary embodiment of the present invention.

Referring to FIG. 4, a main bath B1 is filled with a predetermined volume of an acetone solution. Next, an isopropyl alcohol (IPA) solution is added to the acetone solution with a desired volume ratio to form a mixed solution. It is preferable that the volume ratio of isopropyl alcohol to acetone be in a range of 50:50 to 95:5. The mixed solution is allowed to overflow the main bath B1 into an auxiliary bath B2. Next, a pump is driven to inject the mixed solution contained in the auxiliary bath B2 back to the main bath B1, so that the mixed solution is circulated and mixed. In addition, when a photoresist layer on a wafer is removed, the circulation is continuously performed, so that a removing speed can increase.

Now, a method of fabricating a semiconductor device comprising a photoresist removing process by using a photoresist stripping composition made of a mixed solution of acetone and isopropyl alcohol will be described.

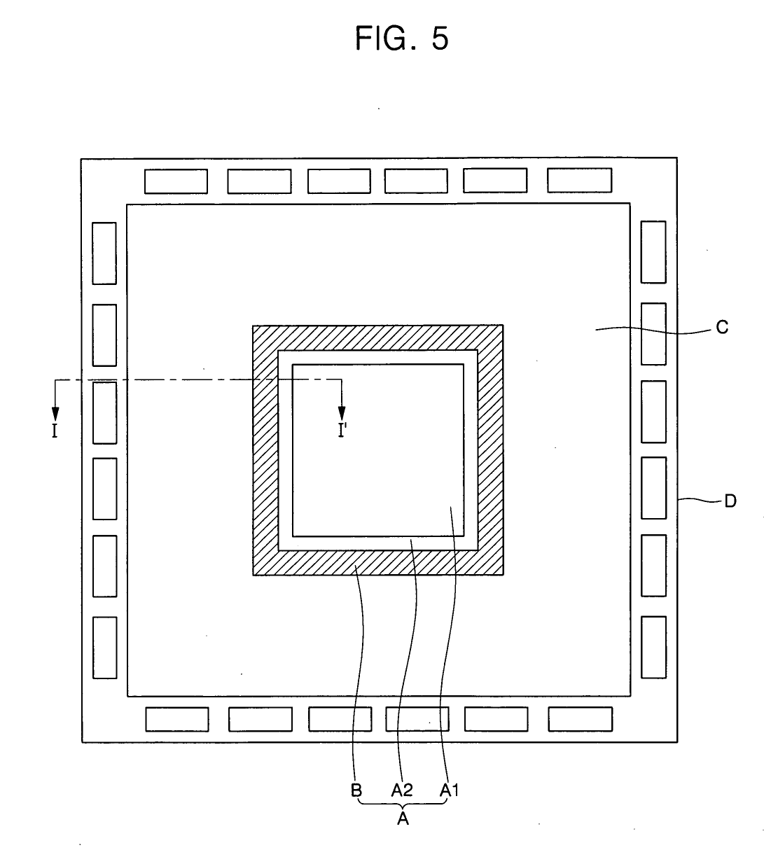

FIG. 5 is a schematic block diagram of image sensors according to an exemplary embodiment of the present invention.

Referring to FIG. 5, image sensors according to an exemplary embodiment of the present invention include a main pixel array region A1. The main pixel array region A1 includes a plurality of main pixels arrayed two-dimensionally in rows and columns. The main pixel array region A1 is surrounded by a light shielding region B. The light shielding region B is constructed with a plurality of reference pixels. A dummy pixel array region A2 is interposed between the main pixel array region A1 and the light shielding region B. The main pixel array region A1, dummy pixel array region A2, and light shielding region B constitute a pixel array region A.

The pixel array region A is surrounded by a peripheral circuit region C. The peripheral circuit region includes row drivers, column drivers, and a logic/analog circuit. The row drivers are disposed at both sides of the main pixel array region A1. The row drivers apply suitable electrical signals to control lines of the main pixels to selectively drive desired main pixels. Moreover, a pad region D is disposed on edges of the image sensors.

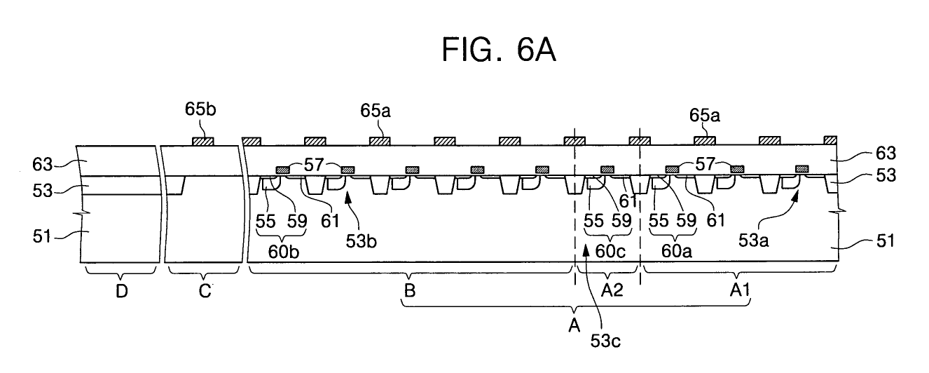

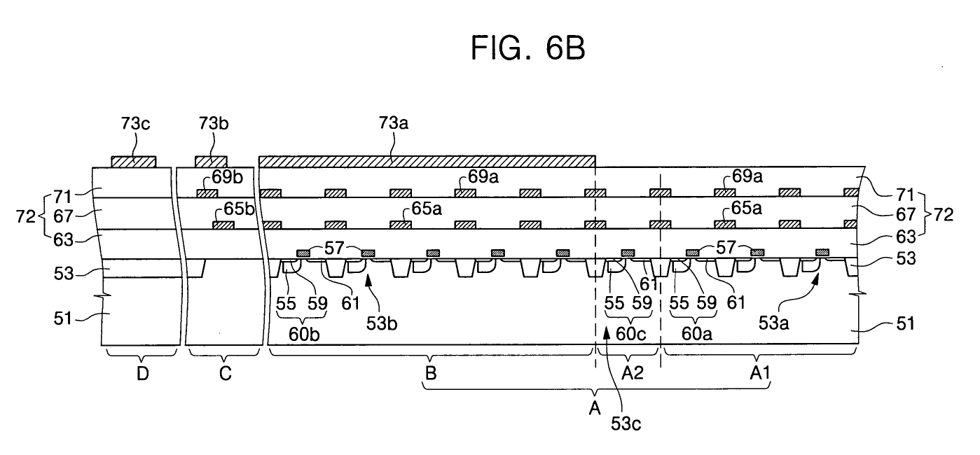

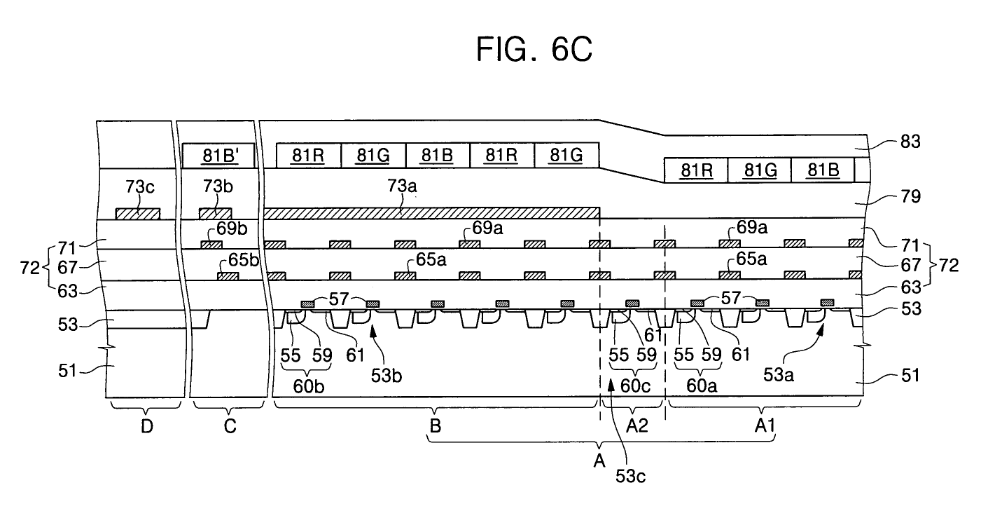

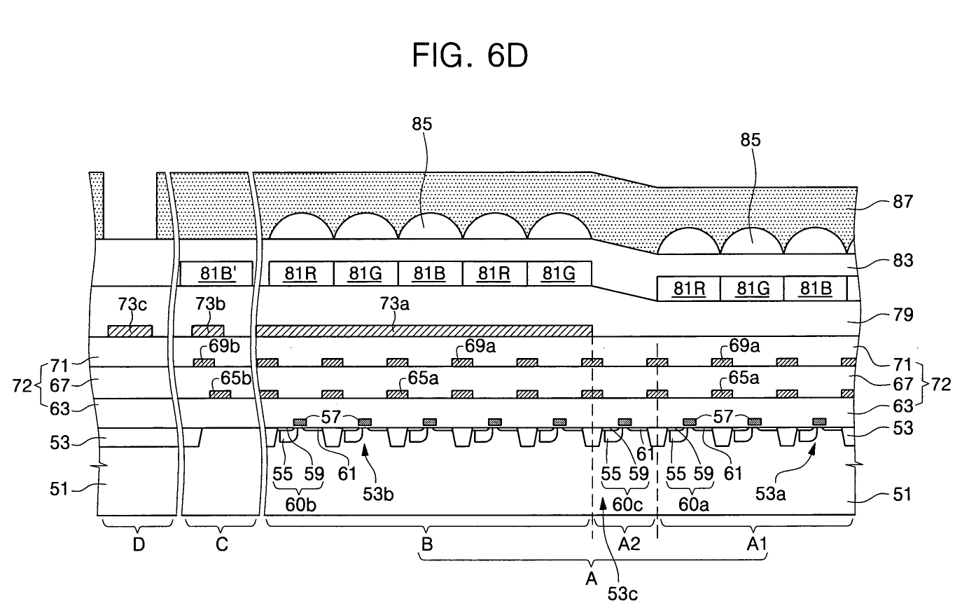

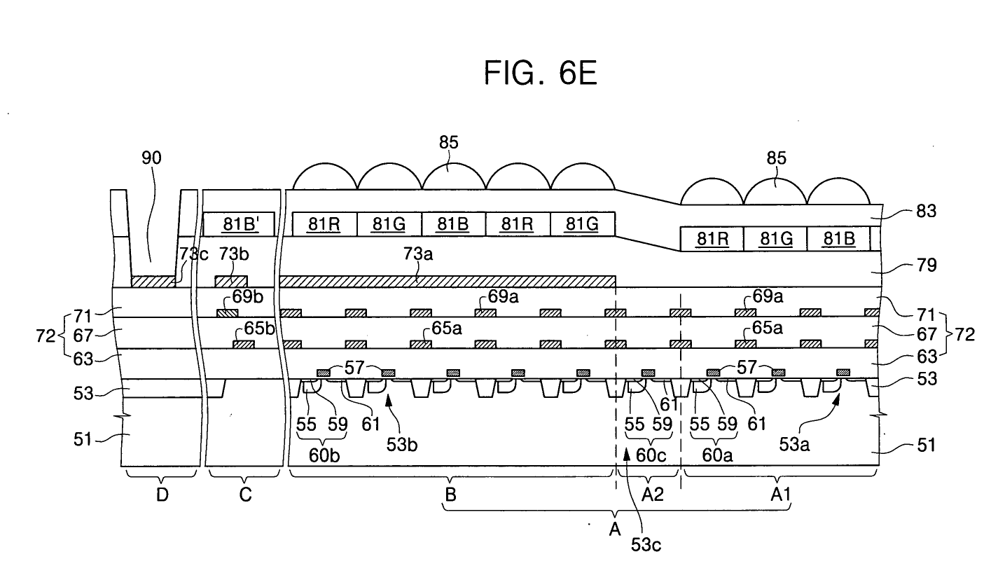

FIGS. 6A to 6E are cross sectional views taken along line I-I′ for explaining methods of fabricating image sensors shown in FIG. 5. In the figures, reference numerals “A”, “C”, and “D” denote a pixel array region, a peripheral circuit region, and a pad region, respectively, and reference numerals “A1”, “A2”, and “B” denotes a main pixel array region, a dummy pixel array region, a light shielding region, respectively, constituting the pixel array region A.

Referring to FIG. 6A, an element isolation layer 53 is formed in a predetermined region of a integrated circuit substrate 51 to define a plurality of pixel active regions in the pixel array region A. In a case where the pixel array region A has the main pixel array region A1, the dummy pixel array region A2, and the light shielding region B, main pixel active regions 53a, dummy pixel active regions 53c, and reference pixel active regions 53b are defined in the main pixel array region A1, the dummy pixel array region A2, and the light shielding region B, respectively. Next, main pixels, reference pixels, and dummy pixels are formed in the main pixel active regions 53a, the reference pixel active regions 53b, and the dummy pixel active regions 53c, respectively.

Each of the main pixels is formed to have a main photodiode 60a, a floating diffusive region 61, and a transfer gate electrode 57 disposed over a channel region between the main photodiode 60a and the floating diffusive region 61. Similarly, each of the reference pixels is formed to have a reference photodiode 60b, a floating diffusive region 61, and a transfer gate electrode 57 disposed over a channel region between the reference photodiode 60b and the floating diffusive region 61. In addition, each of the dummy pixels is formed to have a dummy photodiode 60c, a floating diffusive region 61, and a transfer gate electrode 57 disposed over a channel region between the dummy photodiode 60c and the floating diffusive region 61. Each of the photodiodes 60a, 60b, and 60c is formed to have a deep impurity region 55 and a swallow impurity region 59 surrounded by the deep impurity region 55.

A first interlayer insulating layer 63 is formed on a substrate having the pixels. Moreover, first lower interconnections 65a and second lower interconnections 65b are formed on the first interlayer insulating layer 63. The first lower interconnections 65a and the second lower interconnections 65b are formed in the pixel array region A and peripheral circuit region C, respectively. Each of the first lower interconnections 65a are a localized interconnection for electrically connecting a floating diffusive region 61 to a drive gate electrode of each of the pixels.

Referring to FIG. 6B, a second interlayer insulating layer 67 is formed on a substrate having the first and second lower interconnections 65a and 65b. In addition, first upper interconnections 69a and second upper interconnections 69b are formed on the second interlayer insulating layer 67. The first upper interconnections 69a and second upper interconnections 69b are formed in the pixel array region A and peripheral circuit region C, respectively. The first upper interconnections 69a correspond to control lines of the pixels. The first lower interconnections 65a and the first upper interconnections 69a are formed not to overlap the pixels, particularly, the main photodiodes 60a, thereby maximizing a light-receiving area of the main photodiodes 60a.

A third interlayer insulating layer 71 is formed on a substrate having the first and second upper interconnections 69a and 69b. The first to third interlayer insulating layers 63, 67, and 71 constitute an interlayer insulating layer 72. It is preferable that the interlayer insulating layer 72 have a flat top surface. Namely, it is preferable that at least the third interlayer insulating layer among the first to third interlayer insulating layers 63, 67, and 71 be formed to have a planarized top surface.

A conductive layer is formed on the interlayer insulating layer 72. The conductive layer may be formed of a metal layer such as an aluminum layer. The conductive layer is patterned to form power supply lines 73b and pads 73c in the peripheral circuit region C and the pad region D, respectively. The power supply lines 73b are power source lines and/or ground lines. During the formation of the power supply lines 73b and the pads 73c, a light shielding layer 73a covering the light shielding region B is formed.

Referring to FIG. 6C, a lower planarization layer 79 is formed on a substrate having the light shielding layer 73a. The lower planarization layer 79 is formed of a resin layer such as a polyimide layer. A plurality of pixel color filters are formed on the lower planarization layer 79 by using a general method. The pixel color filters may include red filters 81R, green filters 81G and blue filters 81B arrayed two-dimensionally. Each of the pixel color filters are formed over at least the main pixels. For example, each of the pixel color filters may be formed over the main pixels and the reference pixels. In addition, during the formation of the pixel color filters, a peripheral color filter 81B′ covering the peripheral circuit region C is formed.

The peripheral color filter 81B′ is formed with the same material layer as that of the blue filter 81B. Namely, the peripheral color filter 81B′ and the blue color filter 81B may be simultaneously formed. The blue filter 81B has lower light-transmittance than the red filter 81R and green filter 81G. In other words, the blue filter 81B has higher light-absorbance than the red filter 81R and green filter 81G. Therefore, in a case where the peripheral color filter 81B′ is formed in the peripheral circuit region C, integrated circuits in the peripheral circuit region C are prevented from malfunctioning caused by external light.

An upper planarization layer 83 is formed on a substrate having the color filters 81R, 81G, 81B, and 81B′. The upper planarization layer 83 may also be formed of a resin layer such as a polyimide layer.

Referring to FIG. 6D, a plurality of micro lenses 85, that is, focusing lenses are formed on the upper planarization layer 83. Each of the micro lenses 85 may be formed over at least the main photodiodes 60a. For example, each of the micro lenses 85 are formed over the pixel color filters 81R, 81G, and 81B. The micro lenses 85 are formed of a resin layer such as a polyimide layer. A photoresist layer is formed on a substrate having the micro lenses 85. Next, the photoresist layer is patterned to form a photoresist pattern 87 for exposing the upper planarization layer 83 over the pads 73c of the pad region D.

Referring to FIG. 6E, by using the photoresist pattern 87 as an etching mask, the exposed upper planarization layer 83 and lower planarization layer 79 are sequentially etched to form openings 90 exposing the pads 73c. Next, the photoresist pattern 87 is removed by using a photoresist stripping composition made of a mixed solution of acetone and isopropyl alcohol according to an exemplary embodiment of the present invention.

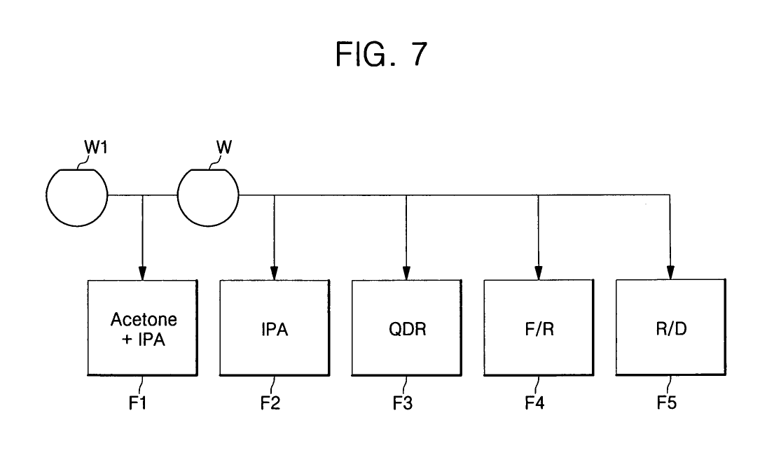

FIG. 7 is a schematic view of a bath for illustrating a process for removing the photoresist pattern by using a photoresist stripping composition made of a mixed solution of acetone and isopropyl alcohol according to an exemplary embodiment of the present invention in FIG. 6E.

Referring to FIG. 7, a wafer W1 having a photoresist pattern is immersed in a bath F1 containing a photoresist stripping composition made of a mixed solution of acetone and isopropyl alcohol (IPA) to peel the photoresist pattern. The photoresist stripping composition is formed by mixing the isopropyl alcohol and the acetone with a volume ratio of acetone to isopropyl alcohol of 50:50 to 95:5. Preferably, the photoresist stripping composition is mixed with a volume ratio of acetone to isopropyl alcohol of 90:10. Preferably, a method of fabricating the photoresist stripping composition includes the steps of: pouring a predetermined amount of an acetone solution in a bath; and adding an isopropyl alcohol solution to the acetone solution in the bath with a desired volume ratio to a form a mixed solution of acetone and isopropyl alcohol. Next, the mixed solution in the bath is circulated.

The wafer is subjected to a reaction in the photoresist stripping composition bath F1 for a time of 30 seconds to 10 minutes. Preferably, the wafer is subjected to a reaction for 3 minutes. At this time, a temperature of the photoresist stripping composition is maintained in a range of about 5 to about 30 degrees Celsius. Preferably, the temperature may be maintained at about 10 degrees Celsius. Next, the wafer W where the photoresist pattern is peeled off is transferred to an isopropyl alcohol (IPA) bath F2 by using a robot arm and rinsed therein. At this time, the rinsing time may be in a range of about 30 seconds to about 5 minutes. Preferably, the rising time is one minute. In a case where the wafer where the photoresist pattern is peeled off is directly transferred to a water bath for rinsing without passing through the isopropyl alcohol bath F2, materials dissolved in the remaining stripper solution may be extracted on the substrate due to a solubility difference between the stripper solution and the other materials in water. Therefore, the isopropyl alcohol bath F2 which is a bath for an intermediate rinsing process using an organic solvent is provided to prevent the materials dissolved in the remaining stripper solution from becoming extracted onto the substrate.

The wafer W rinsed in the isopropyl alcohol bath F2 is transferred to a quick drain rinse (QDR) bath F3 and rinsed by using deionized (D1) water. Next, the wafer W is transferred to a final rinse (F/R) bath F4 and finally rinsed by using deionized water. The rinsing-completed water W is then transferred to a rinse dryer (R/D) bath F5 and dried.

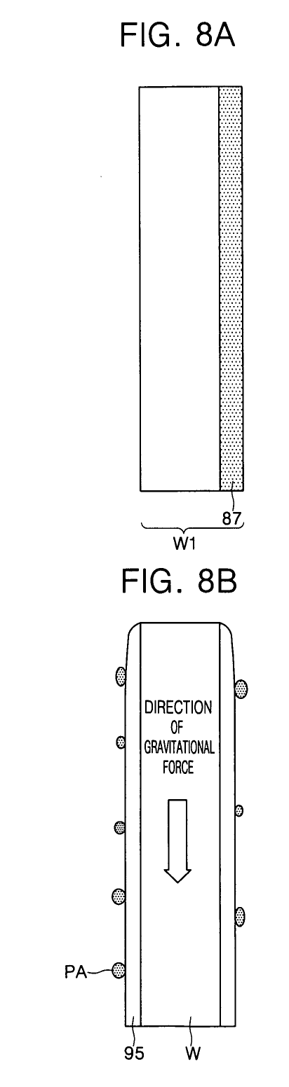

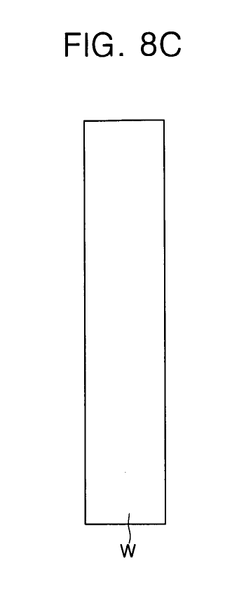

FIGS. 8A to 8C are cross sectional views of a wafer for explaining a process for removing a photoresist pattern by using a photoresist stripping composition according to an exemplary embodiment of the present invention.

Referring to FIGS. 7 and 8A, a wafer W1 having a photoresist pattern 87 is immersed in a bath F1 containing a made of a mixed solution of acetone and isopropyl alcohol according to an exemplary embodiment of the present invention.

Referring to FIGS. 7 and 8B, the photoresist pattern 87 is peeled off in the bath F1 containing the photoresist stripping composition, and after that, the wafer W is lifted up by using a robot arm. At this time, a remaining layer 75 of the photoresist stripping composition is retained on a surface of the wafer W. A Marangoni effect occurs due to a surface tension difference between the acetone solution and the isopropyl alcohol solution, so that it is possible to minimize the number of particles PA contained in the remaining layer 95 of the surface of the wafer W. During the transfer of the wafer W to the next bath by the robot arm, the remaining layer 95 on the surface of the wafer W flows under the wafer due to a gravitational force. As a result, the remaining layer 95 in an upper region of the wafer W becomes thinner.

When the wafer W is transferred from the bath F1 containing the photoresist stripping composition to the isopropyl alcohol bath F2, a solution layer of the isopropyl alcohol component having a low volatility is formed in the remaining layer 95 on the surface of the wafer W, thereby decreasing the volatilization speed of the acetone solution. Therefore, during the transfer of the wafer W between the bath F1 and the bath F2, the particles PA are prevented from being adsorbed into the surface of the wafer W.

Referring to FIGS. 7 and 8C, FIG. 8 shows a wafer W obtained by rinsing the wafer W in the isopropyl alcohol (IPA) bath F2 and sequentially transferring the wafer W to the quick drain rinse (QDR) bath F3, the final rinse (F/R) bath F4, and the rinse dryer (R/D) bath F5 to be rinsed and dried as described in FIG. 7. It can be seen that in the rinsing process all the particles PA contained in a remaining layer 95 on the wafer W are removed. Accordingly, black defect is reduced and production yield is increased when using the photoresist removing process according to the exemplary embodiments of the present invention in comparison to the conventional technique.

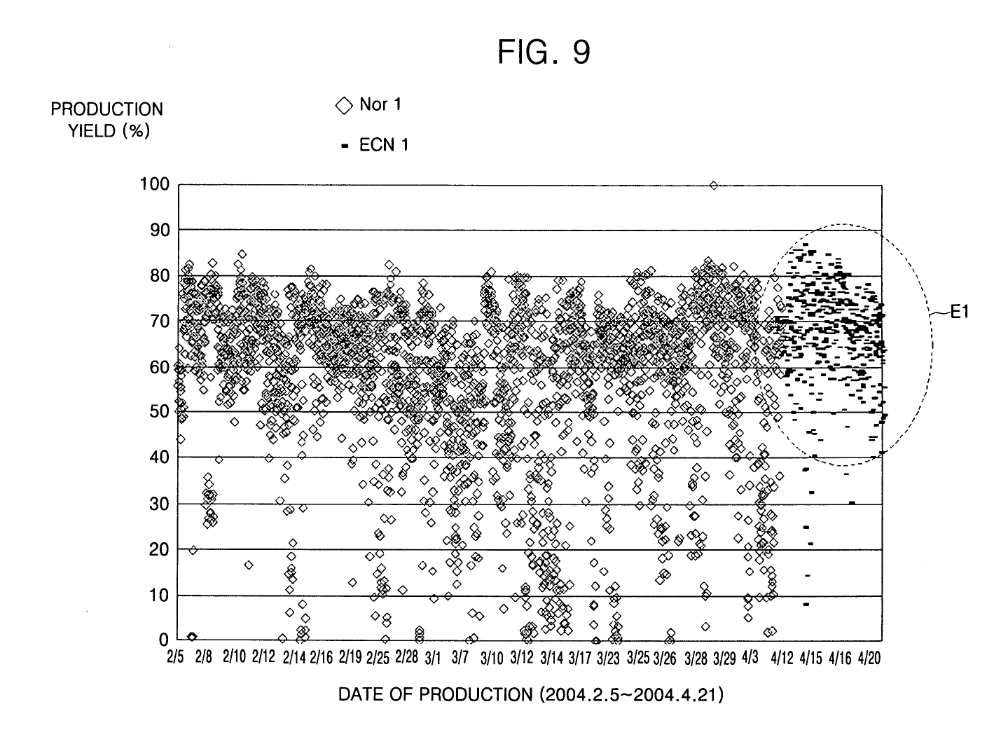

FIG. 9 is a graph comparing production yield of image sensors fabricated by using a conventional technique with production yield of image sensors fabricated by using a photoresist removing process according to the exemplary embodiments of the present invention.

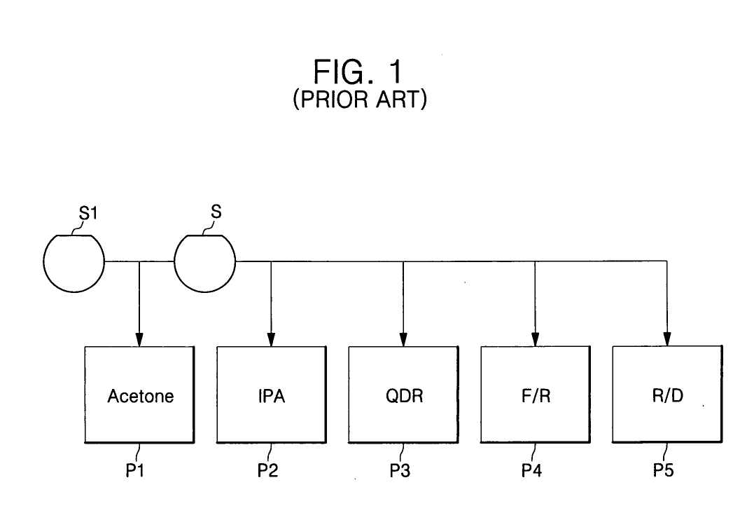

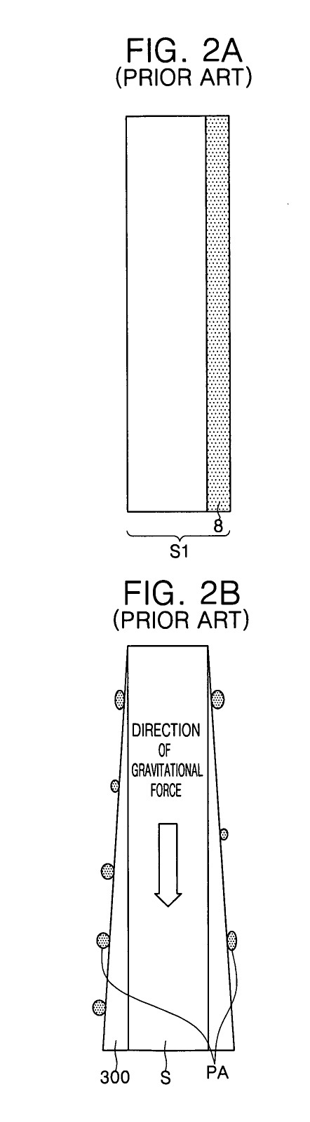

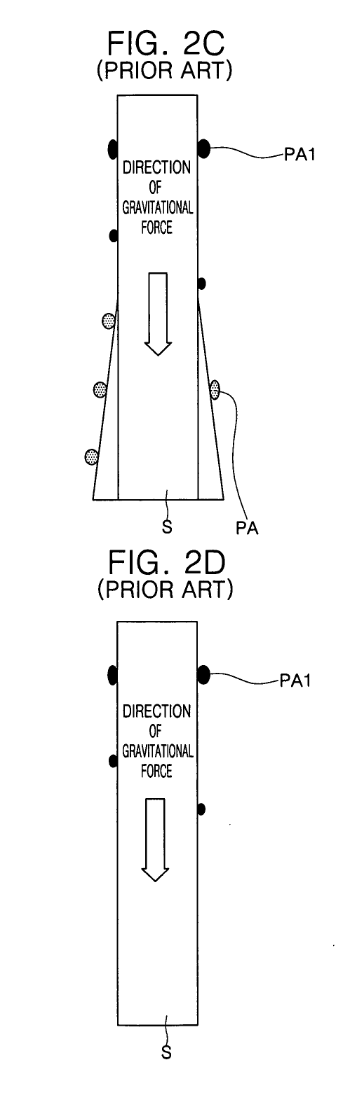

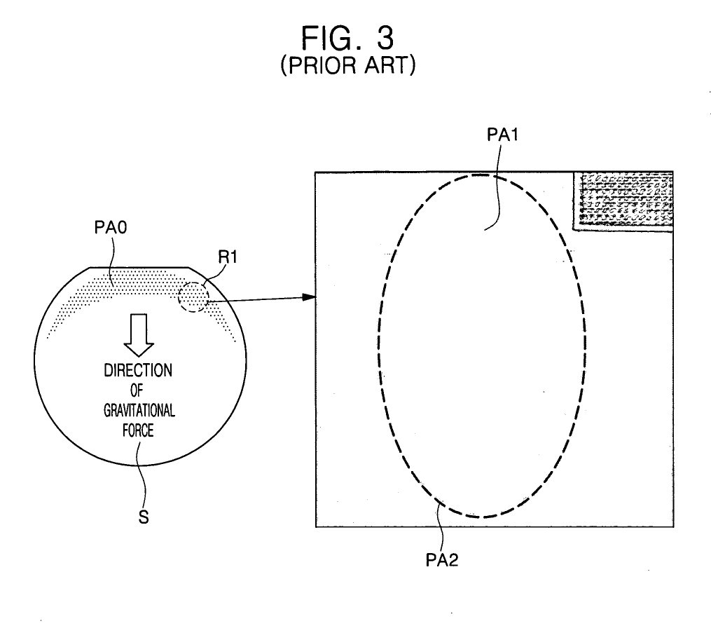

As illustrated in FIG. 1, Nor1 denotes the production yield of image sensors fabricated by using a conventional technique. In addition, as described in FIG. 7, ECN1 denotes the production yield of image sensors fabricated by using a photoresist removing process according to exemplary embodiments of the present invention. Here, the photoresist stripping composition was fabricated by mixing the acetone and the isopropyl alcohol with a volume ratio of the acetone to isopropyl alcohol of 90:10, and the wafer was subjected to a reaction in the photoresist stripping composition bath for 3 minutes. In addition, the temperature of the photoresist stripping composition was maintained at about 10 degrees Celsius, and the wafer was transferred to the isopropyl alcohol (IPA) bath and rinsed for one minute.

As shown in the graph, image sensors were fabricated by using the conventional technique from Feb. 5, 2004 to Apr. 13, 2004, and image sensors were fabricated according to exemplary embodiments of the present invention from Apr. 14, 2004 to Apr. 21, 3004. As can be readily understood, the production yields E1 of the image sensors fabricated by using the photoresist removing process according to the exemplary embodiments of the present invention are improved in comparison to the production yields of the image sensors fabricated using the above conventional technique.

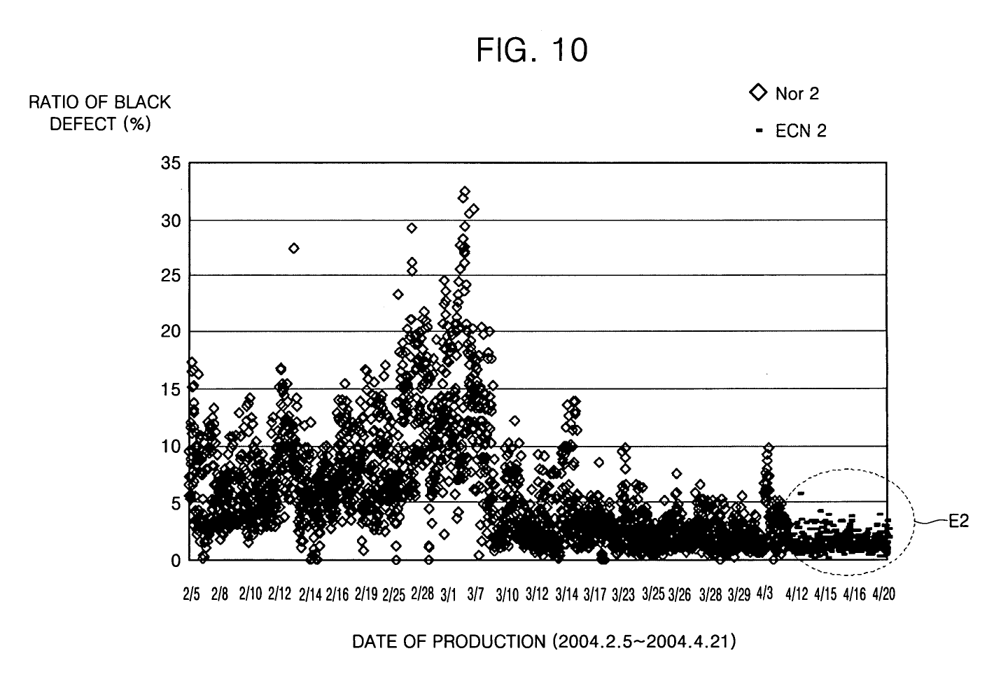

FIG. 10 is a graph showing ratios of black defects to defects generated when image sensors are fabricated according to the conventional technique and the exemplary embodiments of the present invention in FIG. 9.

As illustrated in FIG. 1, Nor2 denotes the ratio of black defects to defects generated when image sensors are fabricated according to the conventional technique. In addition, as illustrated in FIG. 7, ECN2 denotes the ratio of black defects to defects generated when image sensors are fabricated according to the exemplary embodiments of the present invention.

As shown in the graph of FIG. 10, most of the ratios E2 of black defects to defects generated when image sensors are fabricated according to the exemplary embodiments of the present invention were 4% or less. Thus, it is readily understood that defects are greatly reduced when the image sensors are fabricated according to exemplary embodiments of the present invention in comparison to the above-mentioned conventional technique.

As discussed, the exemplary embodiments of the present invention provide a photoresist stripping composition made of a mixed solution of acetone and isopropyl alcohol. A photoresist layer is removed by using the photoresist stripping composition according to the exemplary embodiments, to selectively remove the photoresist layer without leaving any remaining photoresist materials on a rinsed substrate or causing damage to an underlying layer of a photoresist layer. In addition, according to exemplary embodiments of the present invention, during the transfer of a wafer to a photoresist stripping composition bath for rinsing, an isopropyl alcohol forms a solution layer, so that the volatilization speed of the acetone solution is decreased, thereby preventing particle adsorption and minimizing black defect. Further, the production yield of the semiconductor device is also improved by the photoresist stripping compositions and fabrications methods of the exemplary embodiments of the present invention.

Having described the exemplary embodiments of the present invention, it is further noted that it is readily apparent to those of reasonable skill in the art that various modifications may be made without departing from the spirit and scope of the invention as defined by the metes and bounds of the appended claims.

What is claimed is:

1. A photoresist stripping composition consisting essentially of a mixed solution of acetone and isopropyl alcohol.

2. The photoresist stripping composition according to claim 1, wherein a volume ratio of acetone: isopropyl alcohol is in a range of about 50:50 to about 95:5.

3. A method of fabricating a semiconductor device, comprising:
forming an underlayer on a semiconductor substrate;
forming a photoresist layer on the underlayer;
patterning the photoresist layer to form a photoresist pattern;
etching the underlayer by using the photoresist pattern as an etching mask;
immersing the semiconductor substrate in a photoresist stripping composition bath containing a mixed solution of acetone and isopropyl alcohol to remove the photoresist pattern;
transferring the semiconductor substrate to an isopropyl alcohol bath to be rinsed;
transferring the semiconductor substrate to a deionized water bath to be rinsed; and
drying the semiconductor substrate.

4. The method according to claim 3, wherein the photoresist stripping composition is formed by mixing isopropyl alcohol and acetone with a volume ratio of acetone to isopropyl alcohol of about 50:50 to about 95:5.

5. The method according to claim 3, wherein the photoresist stripping composition is prepared by a method comprising:
pouring a predetermined amount of an acetone solution in a bath;
adding the isopropyl alcohol to the bath containing the acetone in a desired volume ratio to form the mixed solution; and
circulating the mixed solution in the bath.

6. The method according to claim 3, wherein a temperature of the photoresist stripping composition is maintained in a range of about 5 to about 20 degrees Celsius.

7. The method according to claim 3, wherein the semiconductor substrate is subject to a reaction in the photoresist stripping composition bath for about 30 seconds to about 10 minutes.

8. The method according to claim 3, wherein when the semiconductor substrate is transferred to an isopropyl alcohol bath to be rinsed, the rinsing time is in a range of about 30 seconds to about 5 minutes.

9. A method of fabricating a semiconductor device, comprising:
preparing a semiconductor substrate where an image sensor having a pad photoresist pattern is provided;
immersing the semiconductor substrate in a photoresist stripping composition bath containing a mixed solution of acetone and isopropyl alcohol to remove the pad photoresist pattern;
transferring the semiconductor substrate to an isopropyl alcohol bath to be rinsed;
transferring the semiconductor substrate to a deionized water bath to be rinsed; and
drying the semiconductor substrate.

10. The method according to claim 9, wherein the photoresist stripping composition is formed by mixing isopropyl alcohol and acetone with a volume ratio of acetone to isopropyl alcohol of about 50:50 to about 95:5.

11. The method according to claim 9, wherein the photoresist stripping composition is prepared by a method comprising:
pouring a predetermined amount of an acetone solution in a bath;
adding the isopropyl alcohol to the bath containing the acetone in a desired volume ratio to form the mixed solution; and
circulating the mixed solution in the bath.

12. The method according to claim 9, wherein a temperature of the photoresist stripping composition is maintained in a range of about 5 to about 20 degrees Celsius.

13. The method according to claim 9, wherein the semiconductor substrate is subject to a reaction in the photoresist stripping composition bath for about 30 seconds to about 10 minutes.

14. The method according to claim 9, wherein when the semiconductor substrate is transferred to an isopropyl alcohol bath to be rinsed, and wherein the rinsing time is in a range of about 30 seconds to about 5 minutes.

15. The method according to claim 9, wherein the step of preparing the semiconductor substrate where the image sensor having the pad photoresist pattern is provided, comprises:
preparing a semiconductor substrate having a pixel array region and a pad region;
forming a plurality of pixels on the semiconductor substrate in the pixel array region;
forming an interlayer insulating layer on the semiconductor substrate having the plurality of pixels, the interlayer insulating layer being formed to have a flat upper surface;
forming a conductive layer on the interlayer insulating layer;
pattering the conductive layer to form pads in the pad region;
forming a lower planarization layer on the semiconductor substrate having the pads;
forming color filters on the lower planarization layer in the pixel array region;
forming an upper planarization layer on the semiconductor substrate having the color filters;
forming micro lenses on the upper planarization layer in the pixel array region;
forming a pad photoresist pattern having openings over the pad region on the semiconductor substrate having the micro lenses; and
etching the upper planarization layer and lower planarization layer by using the pad photoresist pattern as an etching mask to expose the pads.

16. The method according to claim 15, wherein the color filters are formed over the pixels, respectively.

17. The method according to claim 15, wherein the micro lenses are formed over the color filters, respectively.

18. The method according to claim 15, wherein the lower planarization layer is formed of a resin layer.

19. The method according to claim 15, wherein the upper planarization layer is formed of a resin layer.

20. The method according to claim 15, wherein the micro lens is formed of a resin layer.
